(19) United States
(12) Patent Application Publication
(10) Pub. No.: US 2026/0102303 A1
(43) Pub. Date: Apr. 16, 2026

(54) SACRUM MOBILIZATION TOOL

(71) Applicant: Align Athlete LLC, Ann Arbor, MI (US)

(72) Inventor: Mark Thiesmeyer Hook, Ann Arbor, MI (US)

(73) Assignee: Align Athlete LLC, Ann Arbor, MI (US)

(21) Appl. No.: 18/913,544

(22) Filed: Oct. 11, 2024

(51) Int. Cl. A61H 1/00

(52) U.S. Cl. CPC A61H 1/008; A61H 2201/0153; A61H 2201/1695; A61H 2203/0468; A61H 2205/081

(57) ABSTRACT

A device for aligning a sacrum includes a device for aligning a sacrum. The device includes a body having a top portion opposite a bottom portion, and a support portion. The top portion and the bottom portion are attached to the support portion. The body further includes a top lip opposite of a bottom lip, and a pair of side lips. The top lip and the bottom lip each have a pair of ends. The pair of side lips interconnect a corresponding pair of ends of the top lip to a corresponding pair of ends of the bottom lip. A length of the top lip is longer than a length of the bottom lip, and the pair of side lips are arcuate so as to define a wedge-shaped structure having a depression at a center of the body.

### TECHNICAL FIELD

The disclosure relates to a tool for aligning the sacrum of a user.

### BACKGROUND

Physical activities performed by an individual, such as strength training and cardiovascular exercise, create the potential for body pain, strains, and uncomfortableness to develop. Although physical activities are inherently stressful and physically taxing on the body of the individual, the severity of pain and the potential for strains and uncomfortableness is heightened when proper preparation of the body is not performed before physical activities commences. In some instances, especially without proper preparation of the body, minor to severe injuries to the body may develop during physical activities. An important component of body preparation before performing physical activities is proper alignment of the sacrum. A properly aligned sacrum reduces the potential for body injuries to develop, such as injuries associated with the lower back, the hips, the knees, and the ankles.

Sacroiliac (SI) joint pain commonly occurs after activities outside the realm of strength training and cardiovascular exercise, such as an extended period of sitting or sleeping. In many instances, the root cause of SI joint paint is due to the sacrum being flexed to the left or to the right, otherwise known as a unilateral flexed sacrum, side-bending, nutation and counternutation. SI joint pain can result in discomfort and reduced mobility for an individual.

A sedentary lifestyle may also result in SI joint pain. For instance, prolong sitting may result in a misalignment of the sacrum. For example, sitting and sleeping positions may result in a top edge of the sacrum tilting outward of the body and a bottom edge of the sacrum tilted inward toward the body, referred to as a sacrum counternutation. A counternutation weakens internal rotators of the hips, thus increasing the amount of stress of an individual’s hips and knees. Similarly, a sacrum nutation refers to a condition where the bottom edge of the sacrum is excessively tilted outward of the body. For example, it is common for the sacrum to nutate and the gluteus maximus muscle to temporarily cease firing properly as the result of a back injury to an individual. In this scenario, when the gluteus maximus muscle does not fire properly, leg strength is diminished, either to one leg or both legs.

Accordingly, it is desirable to provide a sacrum mobilization tool configured to correct conditions associated with a mis-aligned sacrum.

### SUMMARY

One aspect of the disclosure provides a device for aligning a sacrum. The device includes a body having a top portion opposite a bottom portion, and a support portion. The top portion and the bottom portion are attached to the support portion. The body further includes a top lip opposite of a bottom lip, and a pair of side lips, wherein the top lip and the bottom lip each have a pair of ends and the pair of side lips interconnect a corresponding pair of ends of the top lip to a corresponding pair of ends of the bottom lip. A length of the top lip is longer than a length of the bottom lip, and the pair of side lips are arcuate so as to define a wedge-shaped structure having a depression at a center of the body.

Implementations of this aspect of the disclosure may include one or more of the following optional features. For example, the top lip or the bottom lip may be arcuate so as to curve into the body. In some configurations, the device further includes at least one protrusion. At least one protrusion may be generally centered on the top lip between a first arcuate portion and a second arcuate portion. In another aspect, at least one protrusion is formed of a resilient material and includes a plurality of protrusions, a pair of the plurality of protrusions is disposed in succession along the top lip, one of the plurality of protrusion is disposed along the bottom lip and another pair of the plurality of protrusions is disposed on a corresponding one of the pair of side lips.

In some implementations, the device includes a plurality of ridges that are concentric to each other, wherein a smaller one of the plurality of ridges is recessed with respect to larger one of the plurality of ridges. In some implementations, each of the pair of cut outs is radiused. In some configurations, each of the pair of side lips is generally continuous along an axis from the pair of ends of the top lip and the pair of ends of the bottom lip.

Another aspect of the disclosure provides a tool for aligning the sacrum. The tool includes a bar, a closure, and a body. The body includes a top portion opposite a bottom portion, and a support portion, the support portion configured to be coupled to the closure so as to fix the bar therebetween, wherein the top portion and the bottom portion attached to the support portion. The body further includes a top lip opposite of a bottom lip, and a pair of side lips, wherein the top lip and the bottom lip each have a pair of ends and the pair of side lips interconnect a corresponding pair of ends of the top lip to a corresponding pair of ends of the bottom lip. A length of the top lip is longer than a length of the bottom lip, and the pair of side lips are arcuate so as to define a wedge-shaped structure having a depression at a center of the body.

Implementations of this aspect of the disclosure may include one or more of the following optional features. In some examples, the tool may further include at least one protrusion. In some examples, at least one protrusion is formed of a resilient material and includes a plurality of protrusions. In such an example a pair of the plurality of protrusions is disposed in succession along the top lip. In another example, one of the plurality of protrusion is disposed along the bottom lip. In yet another example, a pair of the plurality of protrusions is disposed on a corresponding one of the pair of side lips. The protrusions may be fixedly attached to the body or may be removably attached to the body. In some further examples, the top lip or the bottom lip may be arcuate so as to curve into the body. In some even further examples, the protrusion is centered within the top lip. In some configurations, the bottom lip includes a pair of cut outs. In some further configurations, each of the pair of cut outs is radiused.

In some examples, each of the pair of side lips is generally continuous along an axis from the pair of ends of the top lip and the pair of ends of the bottom lip. In some implementations, the support portion includes a first mounting groove and the closure includes a second mounting groove, each having a radius that is collectively configured to enclose the bar. In some configurations, the bar includes a pair of grips disposed on opposite ends of the bar. In some examples, the bar includes a pair of end portions, and a middle portion interposed between the pair of end portions, wherein the pair of end portions are angled relative to the middle portion.

In another aspect of the disclosure a method of aligning a sacrum is provided. The method includes the steps of providing a device including a body having a top portion opposite a bottom portion, and a support portion. The top portion and the bottom portion are attached to the support portion. The body further includes a top lip opposite of a bottom lip, and a pair of side lips, wherein the top lip and the bottom lip each having a pair of ends and the pair of side lips interconnecting a corresponding pair of ends of the top lip to a corresponding pair of ends of the bottom lip. A length of the top lip is longer than a length of the bottom lip, and the pair of side lips are arcuate so as to define a wedge-shaped structure having a depression at a center of the body. The method includes the step of placing the device onto the sacrum so as to engage a top portion of the sacrum with the top lip and a bottom portion of the sacrum with the bottom lip and positioning the device so as to grip at least one of the top portion of the sacrum and the bottom portion of the sacrum with the corresponding top lip and bottom lip so as to move the sacrum to until the sacrum is aligned For instance, the sacrum may be moved in three-dimensional space, e.g. in the superior or caudal directions and rotationally to the left/right, into nutation/counternutation or in a clockwise or counterclockwise direction. In one aspect, the method includes the step of providing at least one protrusion and selectively placing at least one protrusion on the body so as to apply a pressure onto a predetermined area of the sacrum.

### BRIEF DESCRIPTION OF THE DRAWINGS

The drawings described herein are for illustrative purposes only of selected configurations and are not intended to limit the scope of the present disclosure.

FIG. 1 is a front view of a tool for aligning a sacrum according to the present disclosure;

FIG. 2 is a rear view of the tool for aligning a sacrum shown in FIG. 1;

FIG. 3 is a front view of a body of the tool for aligning a sacrum shown in FIG. 1;

FIG. 4 is a perspective view of the body shown in FIG. 3;

FIG. 5 is a top plan view of the body shown in FIG. 3;

FIG. 6 is a bottom plan view of the body shown in FIG. 3;

FIG. 7 is a rear view of the body shown in FIG. 3;

FIG. 8 is a front view of a body of the tool for aligning a sacrum shown in FIG. 1 wherein each of a pair of cut outs of the body is radiused.

FIG. 9 is a perspective view of the body shown in FIG. 8;

FIG. 10 is a front view of a body of the tool for aligning a sacrum shown in FIG. 1 wherein each of a pair of side lips is generally continuous along an axis from a pair of ends of a top lip and a pair of ends of a bottom lip.

FIG. 11 is a perspective view of the body shown in FIG. 10;

FIG. 12 a perspective view of a closure of the tool for aligning a sacrum shown in FIG. 1;

FIG. 13 is another perspective view of the closure of FIG. 14;

FIG. 14 is a top down plan view of a tool according to another aspect described herein;;

FIG. 15 is a top down perspective view showing the protrusions engaging a sacrum;

FIG. 16 is a bottom plan view of a tool for aligning a sacrum according to the present disclosure wherein a pair of end grips of a bar are angled with respect to a middle portion of the bar;

FIG. 17 is a bottom plan view of a tool for aligning a sacrum according to the present disclosure wherein a pair of end grips of a bar are parallel to a middle portion of the bar;

FIG. 18 is a perspective view of a user utilizing the tool for aligning a sacrum of FIG. 1

FIG. 19 is a flowchart of a method of aligning a sacrum according to the present disclosure.

FIG. 20 is a posterior view of a sacrum; and

FIG. 21 is a side view of a sacrum.

Corresponding reference numerals indicate corresponding parts throughout the drawings.

### DETAILED DESCRIPTION OF PREFERRED EMBODIMENTS

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

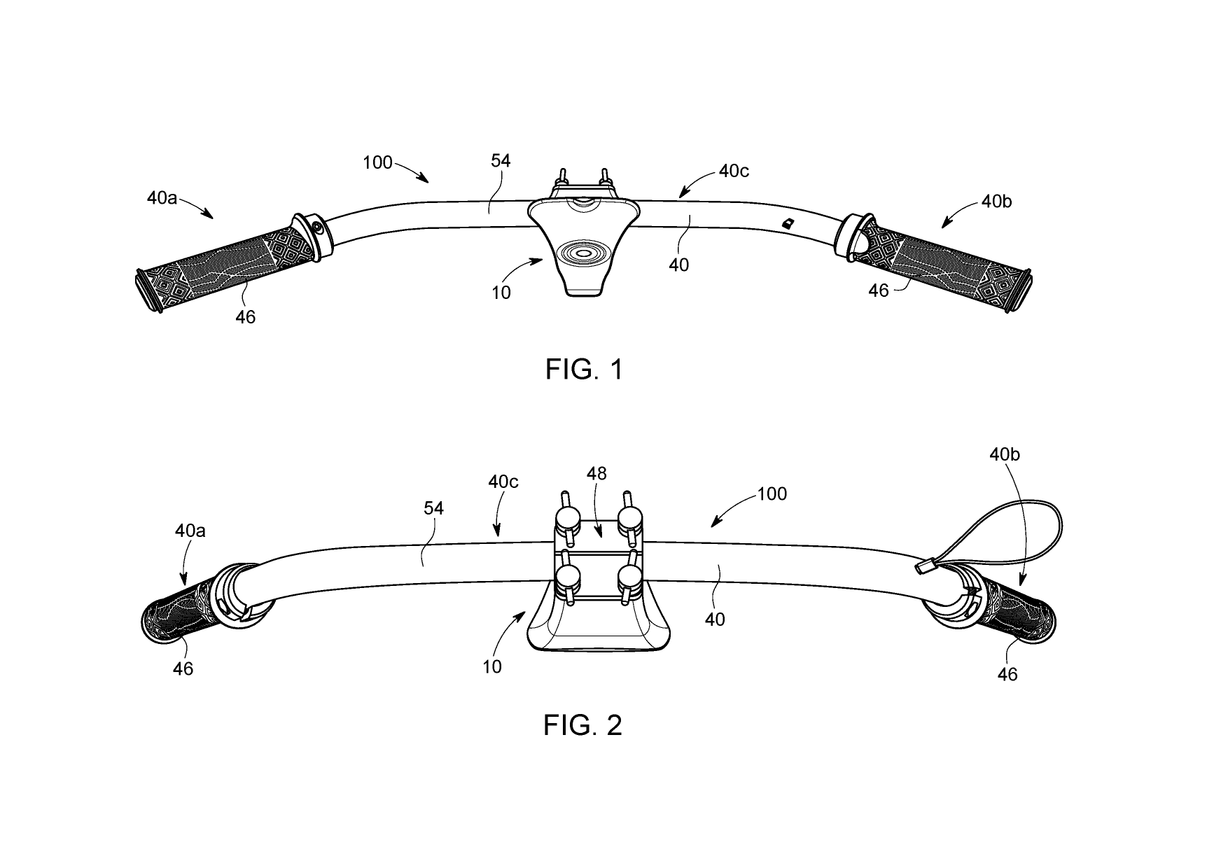

With reference to FIGS. 1-3, a tool 100 is provided. The tool 100 is configured to mobilize/align a sacrum 200 of a user, the operations of which discussed in greater detail below. The tool 100 includes a device 10 configured to engage with a posterior side of a sacrum. In this regard, the device 10 generally corresponds to a size a sacrum so as to enable sufficient and proper engagement. Accordingly, the tool 100 may be larger or smaller than what is depicted in the figures to accommodate different body sizes. Thus, it should be appreciated, however, that the device 10 may vary in size and shape without deviating from the context of this disclosure.

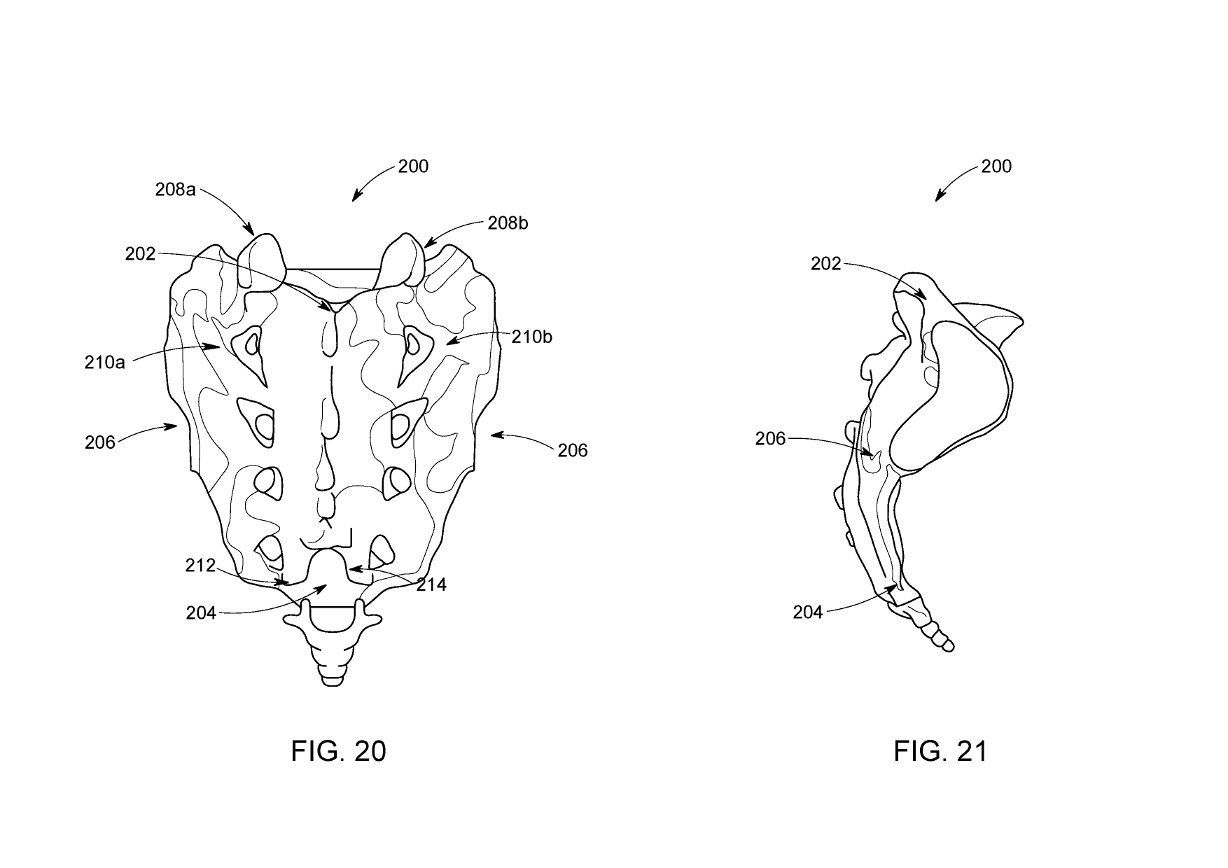

With reference now to FIGS. 20 and 21 a posterior and side view of the sacrum 200 is provided. The sacrum 200 includes a top portion 202, a bottom portion 204 and a pair of sides 206. The sacrum includes a pair of articular facets 208a, 208b disposed at the top portion 202 a left lateral sacral crest 210a and a right lateral sacral crest 210b disposed along the pair of sides 206 and a sacral cornu 212 defining a sacral hiatus 214.

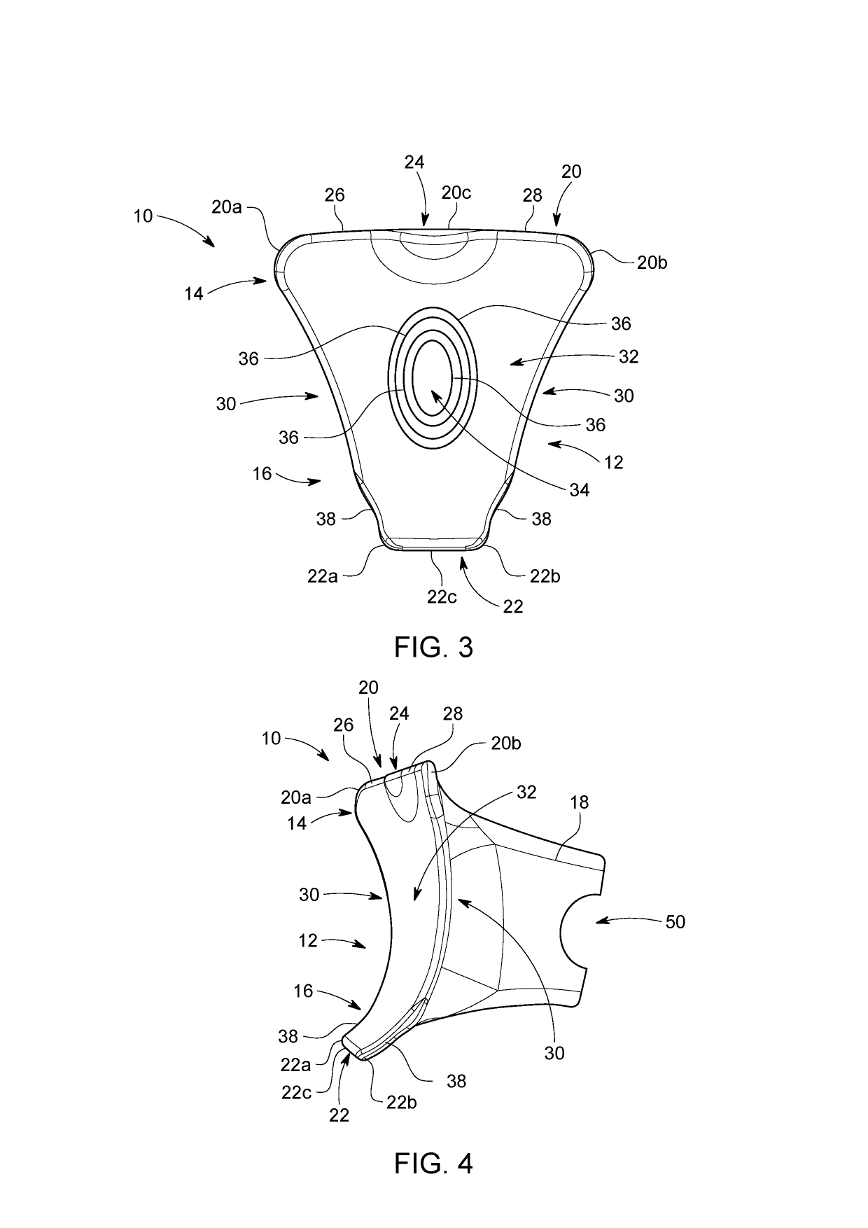

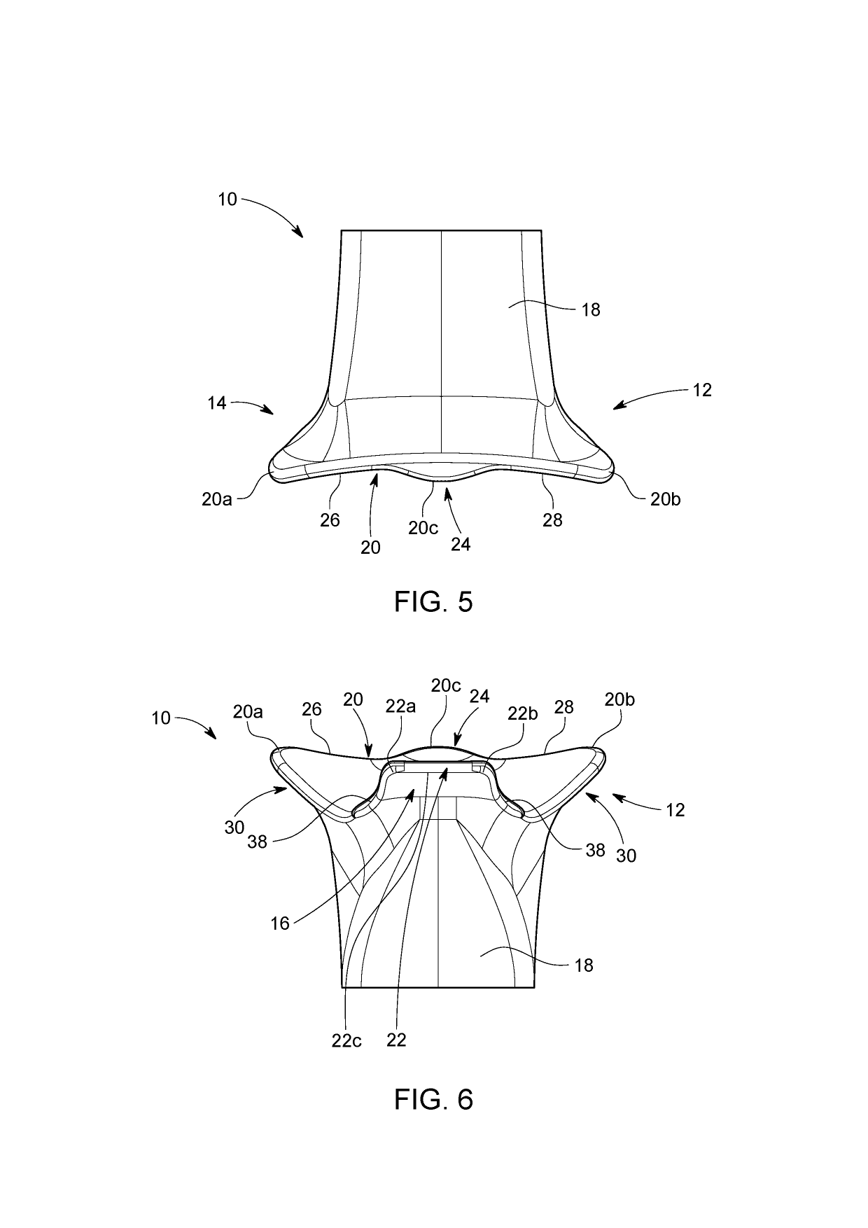

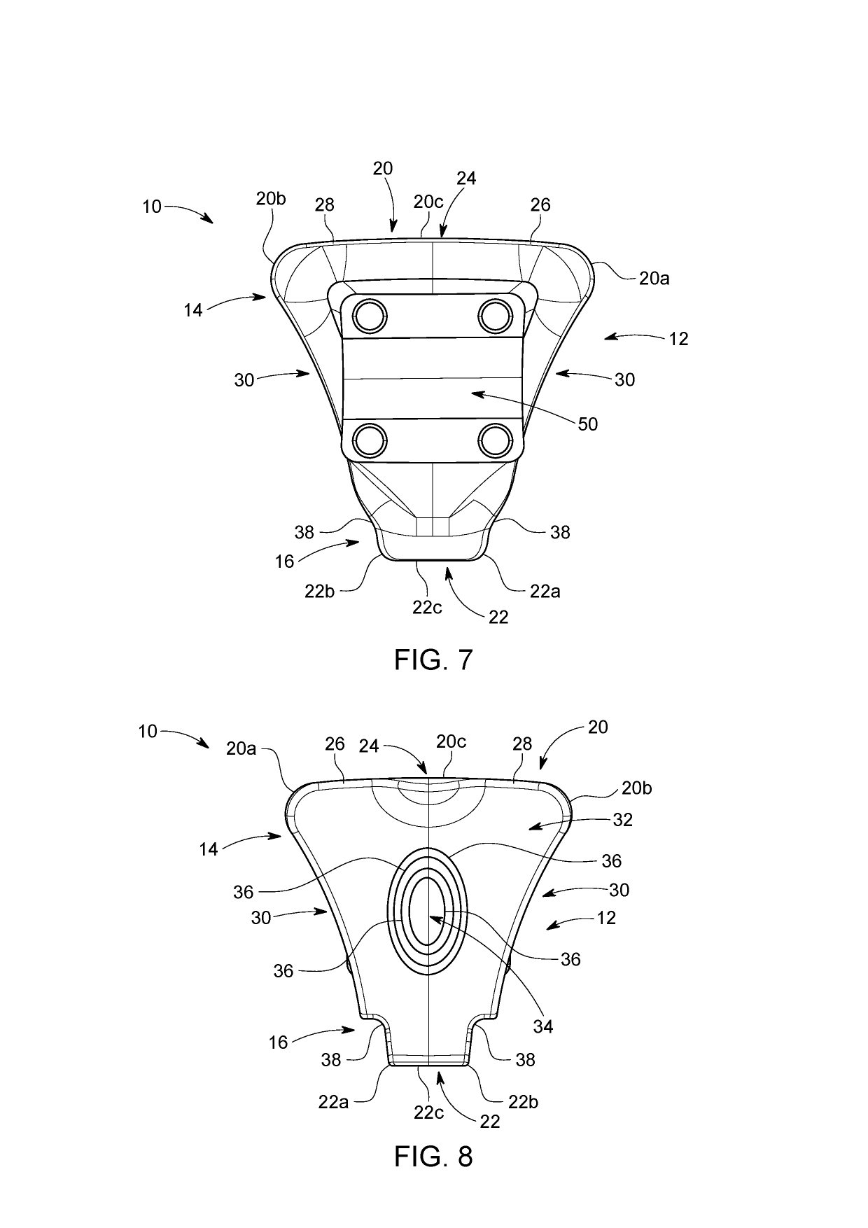

With continued reference to FIG. 3, and now to FIGS. 4-11, the device 10 includes a body 12 that is comprised of a rigid material such as, for example, metal, hard rubber, acrylonitrile butadiene styrene (ABS) plastic, or something of the like, so as to remain undeformed and sturdy when pressure or force is applied during engagement with a sacrum. The body 12 of the device 10 includes a top portion 14 and a bottom portion 16 opposite the top portion 14. Further, the body 12 includes a support portion 18 wherein the top portion 14 and the bottom portion 16 are disposed on the support portion 18. In one aspect, the top portion 14, the bottom portion 16, and the support portion 18 are formed as a unitary piece. For example, the top portion 14 and the bottom portion 16 may be molded to the support portion 18 during manufacture of the device 10. However, it should be appreciated that the top portion 14 and the bottom portion 16 may be formed as a unitary piece and mechanically attached to the support portion 18 using any known attachment means, such as a bolt, a screw, or the like.

The body 12 further includes a top lip 20 disposed at a distal end of the top portion 14, and a bottom lip 22 disposed at a distal end of the bottom portion 16. The top lip 20 includes a length that is greater than a length of the bottom lip 22. In this regard, the top lip 20 is configured to interface with the portion of a sacrum that is at or near the pair of superior articular facets, while the bottom lip 22 is configured to interface with the portion of a sacrum that is at or near the coccyx. The top lip 20 includes a pair of ends 20a, 20b that define the length of the top lip 20, while the bottom lip 22 includes a pair of ends 22a, 22b that define the length of the bottom lip 22. In the illustrative examples, both of the pairs of ends 20a, 20b, 22a, 22b are generally rounded. However, it should be appreciated that both of the pairs of ends 20a, 20b, 22a, 22b may be squared, angled, or rounded to a greater or a lesser extent than what is shown in the illustrative examples without deviating from the context of this disclosure.

Both the top lip 20 and the bottom lip 22 partially flare outwardly of the body 12 in a direction away from the support portion 18. In one aspect, both the top lip 20 and the bottom lip 22 are arcuate so as to curve inward toward the body 12. In this regard, the pair of ends 20a, 20b of the top lip 20 are flared a distance further from the body 12 than a center portion 20c of the top lip 20. In a similar manner, the pair of ends 22a, 22b of the bottom lip 22 are flared a distance further from the body 12 than a center portion 22c of the bottom lip 22.

With continued reference to FIGS. 3-8, the top lip 20 may include a protrusion 24 positioned at the center portion 20c of the top lip 20. The protrusion 24 is generally radiused and extends away from the top lip 20 and outwardly of the body 12 in a direction away from the support portion 18 and is integrally formed to the body 12. Due to the top lip 20 being arcuate so as to curve into the body 12, the protrusion 24 may extend a greater distance or a lesser distance away from the body 12 compared to the pair of ends 20a, 20b, of the top lip 20. In other words, if the protrusion 24 is relatively minor in size, the pair of ends 20a, 20b may extend a distance further away from the body 12 compared to the protrusion 24. If the protrusion 24 is relatively great in size, the protrusion 24 may extend a distance further away from the body 12 compared to the pair of ends 20a, 20b. The top lip 20 further includes a first arcuate portion 26 and a second arcuate portion 28 opposite the first arcuate portion 26. The first arcuate portion 26 is disposed between one of the pair of ends 20a of the top lip 20 and the protrusion 24, while the second arcuate portion 28 is disposed between the other of the pair of ends 20b of the top lip 20 and the protrusion 34. In this regard, the protrusion 24 defines both the first arcuate portion 26 and the second arcuate portion 28. The positioning of the protrusion 24 at the center portion 20c of the top lip 20 corresponds to the first arcuate portion 26 and the second arcuate portion 28 being equal in length.

The body 12 further includes a pair of side lips 30 positioned opposite of one another. The pair of side lips 30 interconnect the pair of ends 20a, 20b of the top lip 20 with the corresponding pair of ends 22a, 22b of the bottom lip 22. As shown in FIG. 3, one side lip 30 connects the end 20a of the top lip 20 to the end 22a of the bottom lip 22, while the other side lip 30 connects the end 20b of the top lip 20 to the end 22b of the bottom lip 22. Furthermore, the pair of side lips 30 are arcuate, so as to curve inward toward each other and give the body 12 a wedge-shaped structure.

With specific reference to FIG. 4, the pair of side lips 30 curve inward toward the body 12 between the pair of ends 20a, 20b, 22a, 22b, respectively, wherein the pair of side lips 30 partially define a depression 32 disposed generally at a center portion 34 of the body 12. The depression 32 is also partially defined by a plurality of ridges 36 positioned at the center portion 34 of the body 12. The plurality of ridges 36 may vary in size and are concentric to each other, wherein a smaller one of the plurality of ridges 36 is recessed with respect to a larger one of the plurality of ridges 36. In other words, the depression 32 gradually becomes greater towards the center portion 34 of the body 12 as the plurality of ridges 36 become smaller and more recessed into the body 12. While the curvatures as described above of the top lip 20, the bottom lip 22, and the pair of side lips 30 attribute to the depression 32, the plurality of ridges 36 enhance the extent of the depression 32.

The pair of side lips 30 may be differently configured so as to enable varying embodiments of the device 10. In one configuration, as seen in FIGS. 3-9, each of the pair of side lips 30 include a cut out 38 wherein each cut out 38 is opposite one another. Each cut out 38 is positioned towards the bottom portion 16 of the body 12 and abuts against the pair of ends 22a, 22b, respectfully, of the bottom lip 22. Furthermore, each cut out 38 may partially extend inward towards the body 12 in a slightly curved manner. In this regard, the extent each cut out 38 extends inward toward the body 12 defines a length of the bottom lip 22. The greater each cut out 38 extends inward toward the body 12, the lesser a length of the bottom lip 22.

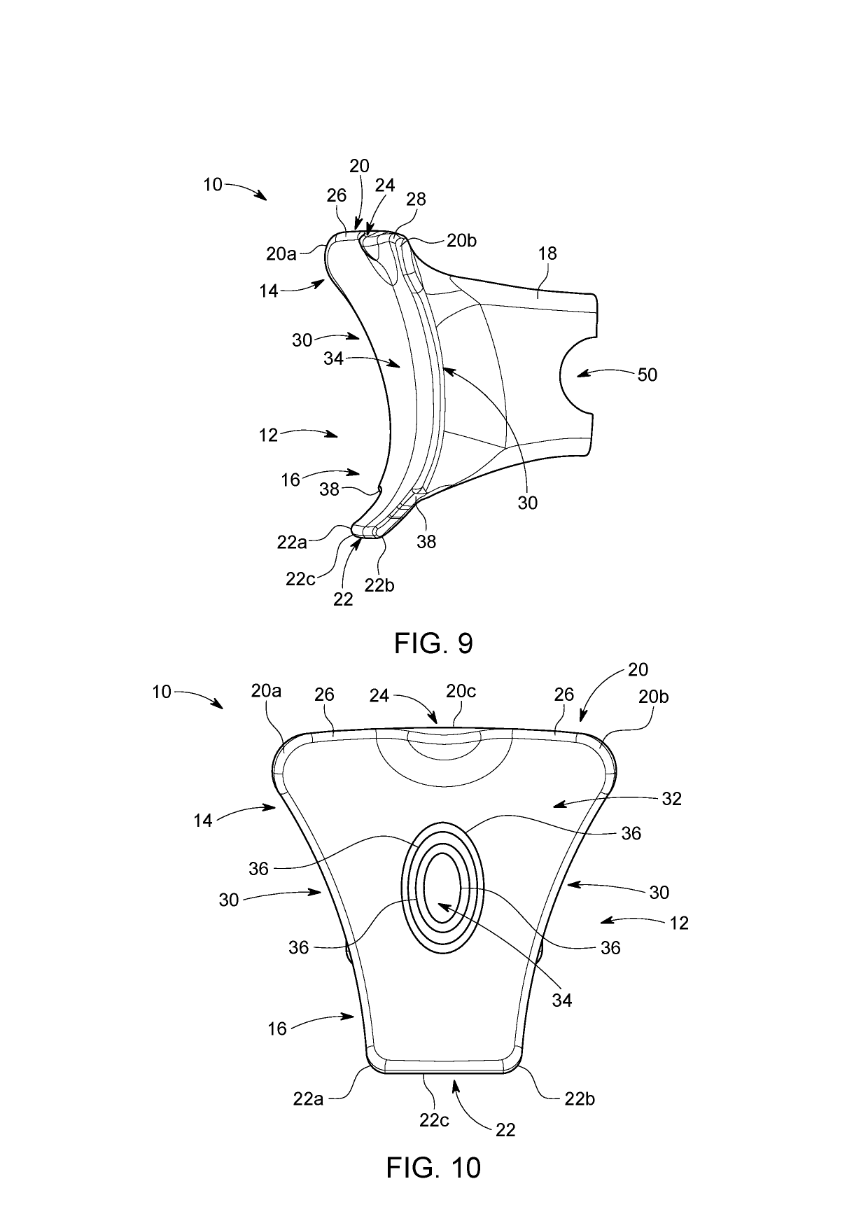

In another configuration, and with respect to FIGS. 8 and 9, each of the pair of side lips 30 includes a cut out 38 that is radiused wherein each cut out 38 is opposite one another. Each cut out 38 is positioned toward the bottom portion 16 of the body 12 and abuts against the pair of ends 22a, 22b, respectfully, of the bottom lip 22. Furthermore, each cut out 38 partially extends inward toward the body 12 in a radiused manner. In this regard, the extent each cut out 38 extends inward toward the body 12 defines a length of the bottom lip 22. The greater each cut out 38 extends inward toward the body 12, the lesser a length of the bottom lip 22. Furthermore, since each cut out 38 is radiused, the curvature of each cut out 38 may be at or near 90 degrees. It should be appreciated, however, that the degree of curvature of each cut out 38 may vary without deviating from the context of this disclosure.

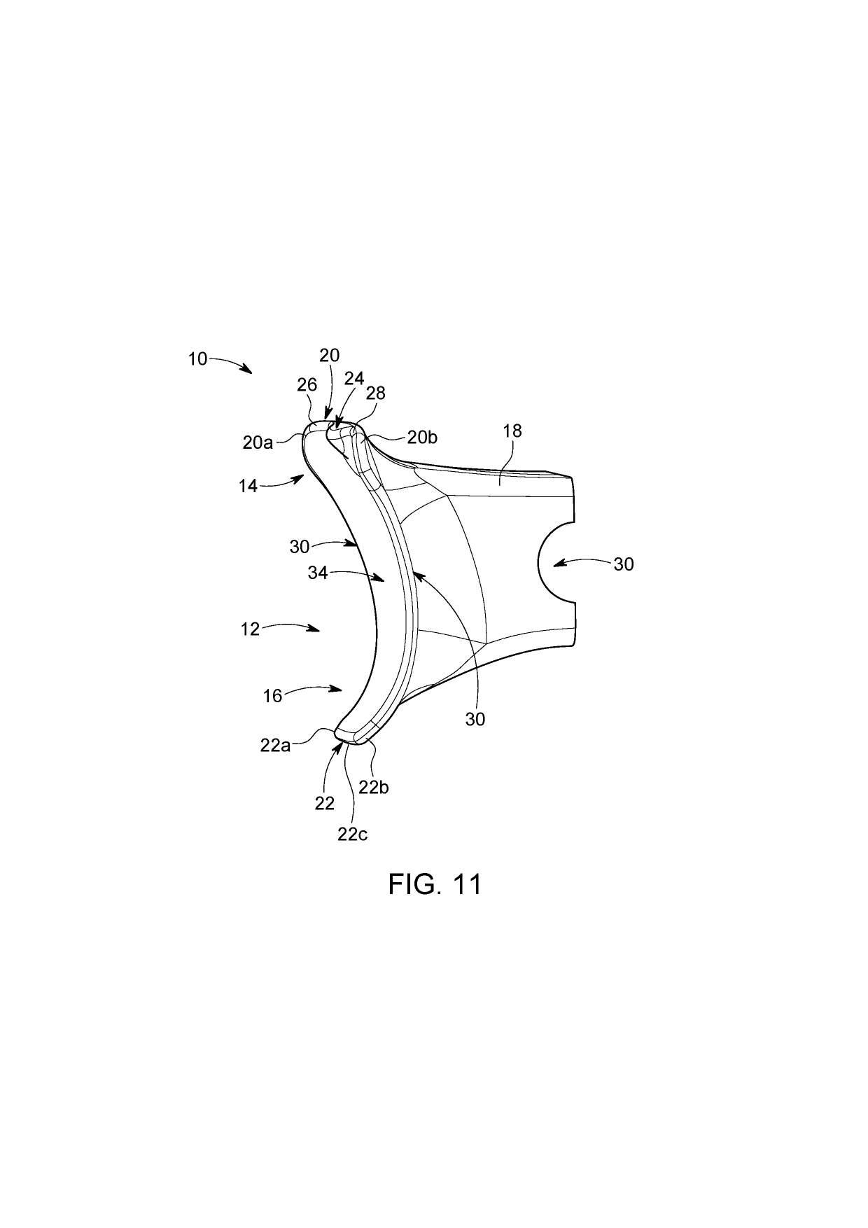

In another configuration, and with respect to FIGS. 10 and 11, the pair of side lips 30 are generally continuous between the pair of ends 20a, 20b of the top lip 20 and the pair of ends 22a, 22b of the bottom lip 22. In other words, the pair of side lips 30 are free of cut outs, indentations, or protrusions between the pair of ends 20a, 20b, 22a, 22b.

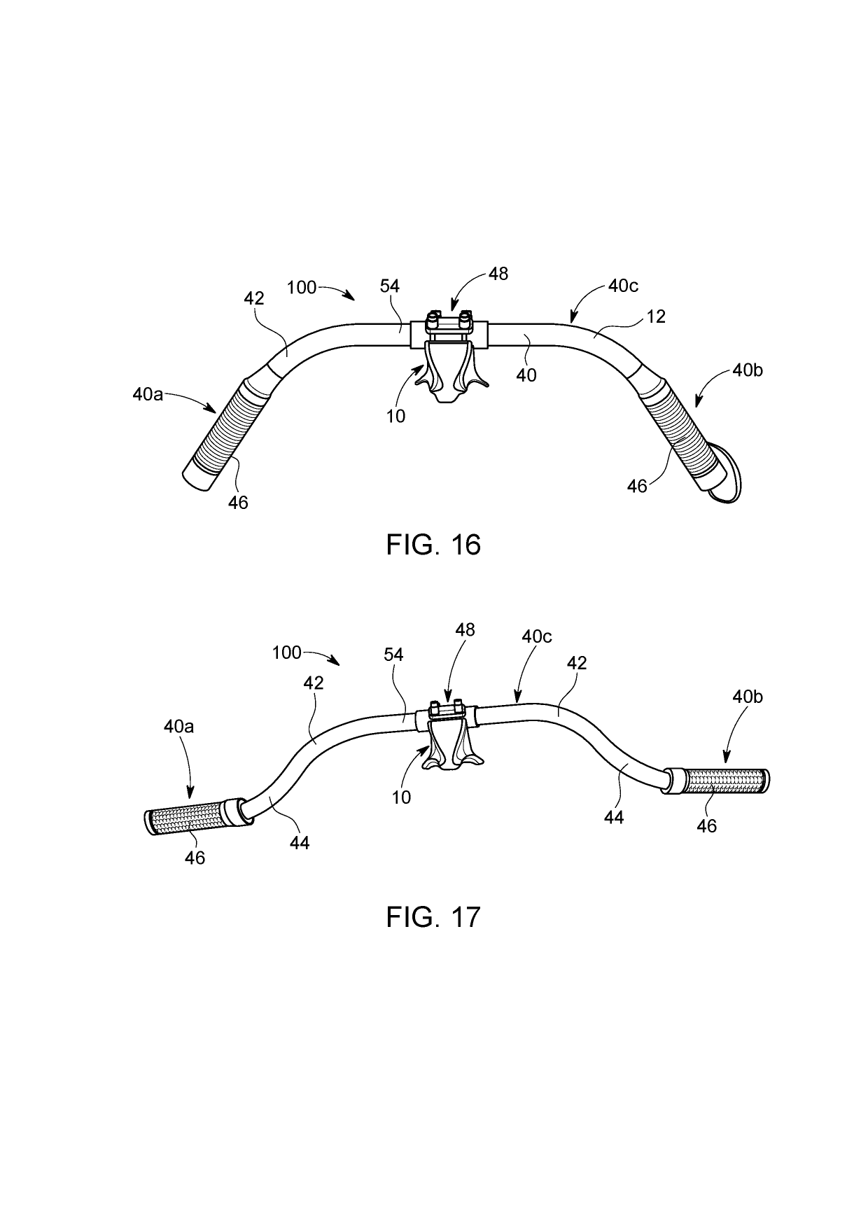

With reference to FIGS. 16 and 17, the tool 100 also includes a bar 40. The bar 40 is made of a rigid material such as, for example, metal, that maintains its shape when a pressure or force sufficient to move a sacrum is applied. As shown in the illustrated example, the bar 40 is tubular in shape in that a cross-section of the bar 40 is circular or ovoid. However, it should be appreciated that the bar 40 may be differently shaped, such as rectangularly or squarely shaped, without deviating from the context of this disclosure.

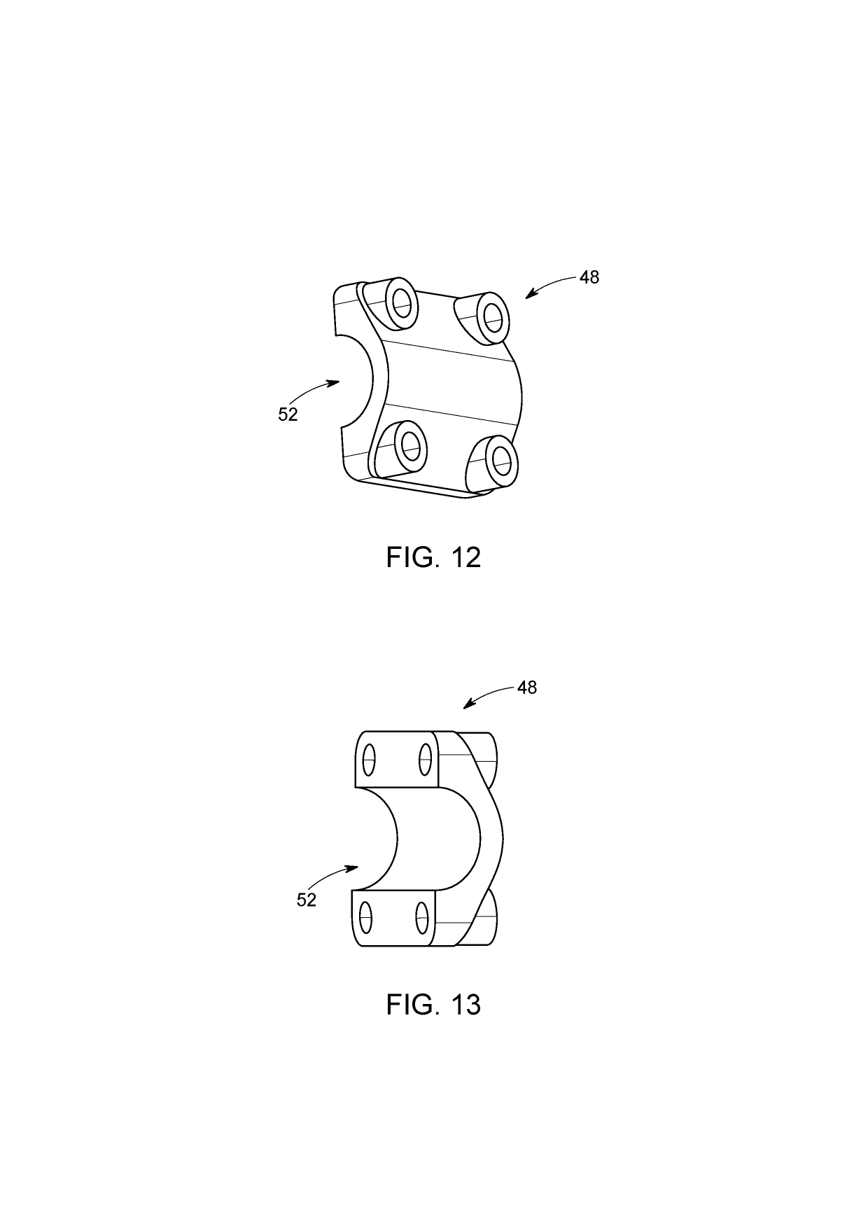

The bar 40 includes a pair of end portion 40a, 40b at opposing distal ends of the bar 40. Interposed between the pair of end portions 40a, 40b is a middle portion 40c. With specific reference to FIG. 12, in one configuration, the middle portion 40c of the bar 40 may include a first pair of bends 42. Each of the first pair of bends 42 may be angled so as to position the each of the pair of end portions 40a, 40b at an intersecting angle relative to the middle portion 40c. Further, each of the first pair of bends 42 may be angled so as to position the each of the pair of end portions 40a, 40b at an intersecting angle relative to one another. In another configuration, and with specific reference to FIG. 13, the middle portion 40c of the bar 40 may include a second pair of bends 44 in addition to the first pair of bends 42. The first pair of bends 42 may be angled so as to angle the pair of end portions 40a, 40b toward one another, while the second pair of bends 44 may be angled so as to angle the pair of end portions 40a, 40b away from one another. In this regard, the pair of end portions 40a, 40b may be generally co-planar relative to the middle portion 40c wherein the pair of end portions 40a, 40b and the middle portion 40c are positioned along differing axes. Furthermore, the pair of end portions 40a, 40b may be generally co-planar to one another along the same axis.

It should be appreciated that the first pair of bends 42 and the second pair of bends 44 may be differently angled than what is shown in the illustrative examples without deviating from the context of this disclosure. Further, it should be appreciated that the middle portion 40c of the bar may be differently configured than described above without deviating from the context of the disclosure. For example, the middle portion 40c of the bar 40 may be straight wherein the bar 40 is positioned along a single axis and is free of bends. In another example, the middle portion 40c of the bar 40 may include additional bent portions in addition to the first pair of bends 42 and the second pair of bends 44. The varying configurations of the bar 40 as described above may be tailored to enhance the ergonomics and comfortability of the tool 100 during operation.

Included at the pair of end portions 40a, 40b is a pair of grips 46 configured to engage with the hands of a user during operation of the tool 100. One of the pair of grips 46 is disposed at one of the pair of end portions 40a, while the other of the pair of grips 46 is disposed at the other of the pair of end portions 40b. The pair of grips 46 may be of a rubber, plastic, a tape, metal, or foam material, or something of the like. Further, the pair of grips 46 may include ridges, texture, or something of the like to enhance the coefficient of friction of the pair of grips 46 against the hands of a user. The pair of grips 46 may be integrally formed with the end portions 40a, 40b of the bar 40. Alternatively, the pair of grips 46 may be affixed to the end portions 40a, 40b of the bar 40. Affixing the pair of grips 46 to the end portions 40a, 40b of the bar 40 may be achieved via press fitment, adhesive, bolts, screws, or something of the like.

With reference to now to FIGS. 12 and 13, the tool 100 may also include a closure 48 configured to fixedly attach to the device 10 at the support portion 18. The attachment of the closure 48 to the support portion 18 may be achieved via bolts, screws, adhesive, or something of the like so as to create a rigid connection. Further, the closure 48 is comprised of a rigid material such as, for example, metal, hard rubber, acrylonitrile butadiene styrene (ABS) plastic, or something of the like, so as to remain undeformed and sturdy when pressure or force is applied.

When the tool 100 is fully assembled, the closure 48 is fixedly attached to the support portion 18 wherein a first mounting groove 50 of the support portion 18 interfaces with a second mounting groove 52 of the closure 48. Disposed between the support portion 18 and the closure 48 is the middle portion 40c of the bar 40 wherein the bar 40 simultaneously engages with the first mounting groove 50 of the support portion 18 and the second mounting groove 52 of the closure 48. In this regard, both the first mounting groove 50 and the second mounting groove 52 are radiused so as to fittingly receive an outer surface 54 of the bar 40 and enclose the bar 40. In other words, the outer surface 54 of the bar 40 is configured to be seated within the first mounting groove 50 and the second mounting groove 52.

Increasing the level of securement of the closure 48 to the support portion 18 simultaneously increases the level of securement of the bar 40 between the first mounting groove 50 and the second mounting groove 52. For example, if the closure 48 is fixedly attached to the support portion 18 via bolts, wherein the outer surface 54 of the bar 40 is firmly seated within the first mounting groove 50 and the second mounting groove 52, the bolts may be tightened to increase the level of securement of the closure 48 to the support portion 18. As the bolts are tightened, the first mounting groove 50 and the second mounting groove 52 concurrently tighten against the outer surface 54 of the bar 40, increasing the level of securement of the bar 40 via squeezing the outer surface 54 of the bar 40 between the first mounting groove 50 and the second mounting groove 52. The increased securement of the bar 40 between the closure 48 and the support portion 18 may prevent twisting or other unwanted movement of the bar 40 relative to the device 10 and the closure 48 during operation of the tool 100. It should be appreciated that the depiction of the closure 48 is illustrative and not limiting. That is, the closure 48 is shown including four through-holes for receiving a screw or bolt to fasten the closure 48 to the support portion 18. However, it should be appreciated that the closure 48 may include a single or multiple through-hole(s) within the closure 48, wherein the bolt(s) or screw(s) would pass through the closure 48, the bar 40 and the support portion 18. In such an aspect, the bolt(s) or screw(s) would not only secure the bar 40 to the support portion 18, but would also prevent rotation of the bar 40 within the first mounting groove 50 and the second mounting groove 52 of the corresponding support portion 18 and closure 48.

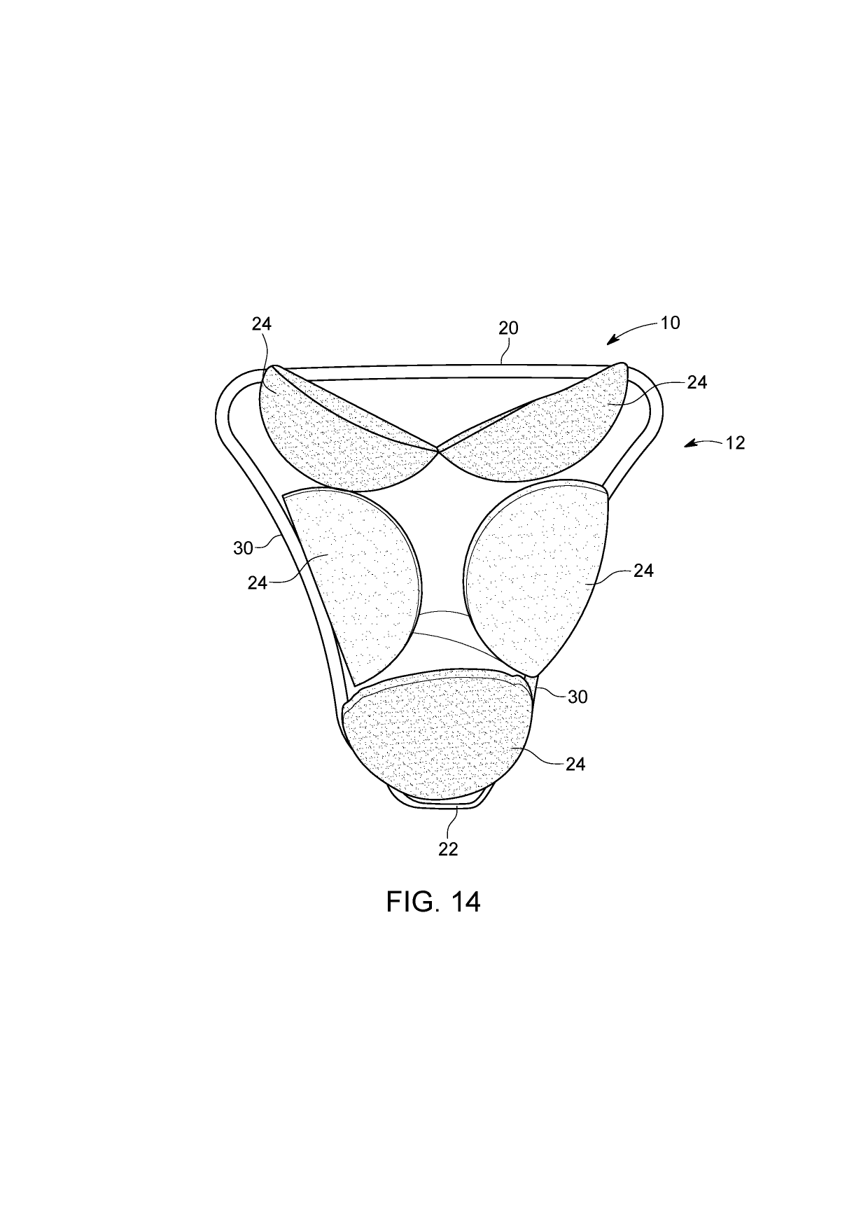

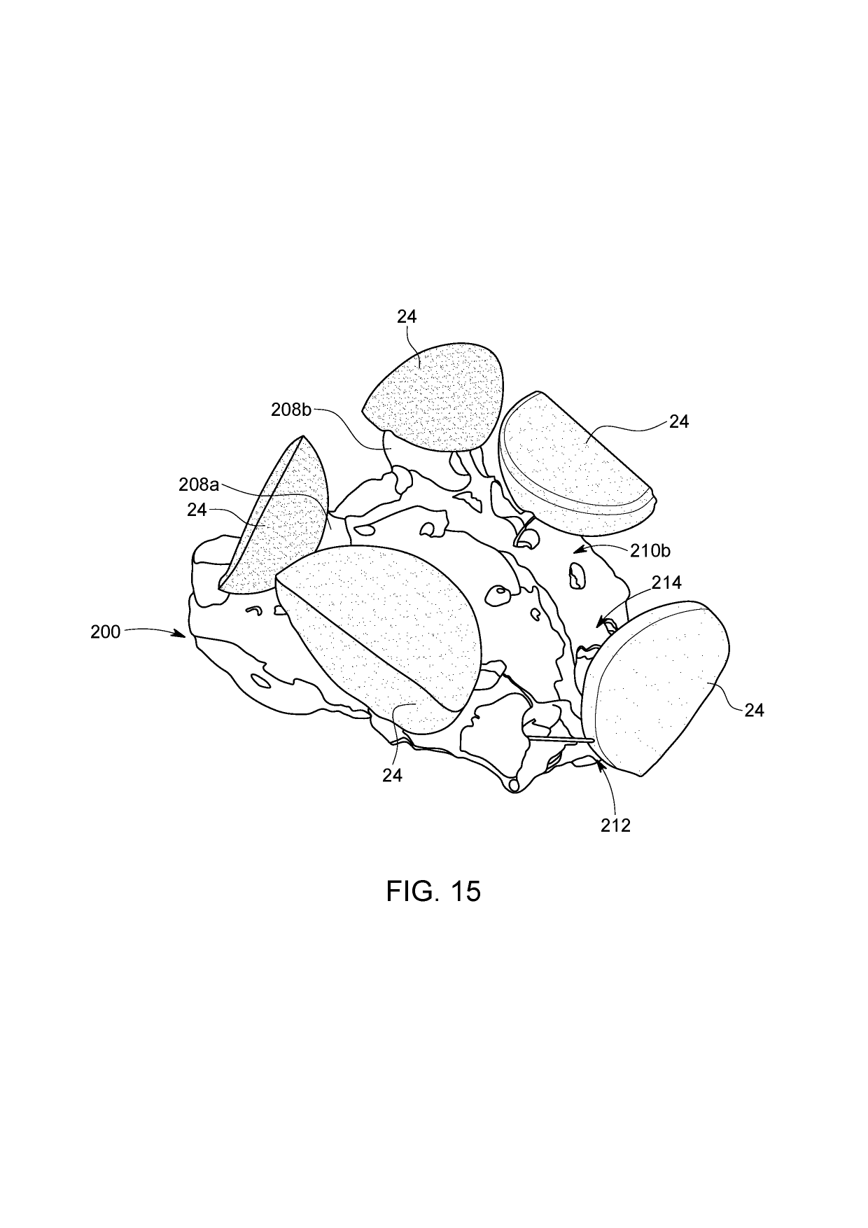

With reference now to FIGS. 14 and 15, the device 10 includes at least one protrusion 24. In one aspect, the protrusions 24 are formed of a resilient material and may be fixed to the body 12 by any known fixing means, to include a mechanical fastener such as a screw or an adhesive. In another aspect, the protrusions 24 are detachably mounted onto the body 12. In such a case, the body 12 may include a first fastening strip and a bottom surface of the protrusions 24 may include a second fastening strip configured to releasably engage the first fastening strip. In such a case, the device 10 includes a plurality of protrusions 24 that may be selectively attached to the body 10. For instance, a pair of the plurality of protrusions 24 is attached to the top lip 20 of the body 12 in succession so as to engage at or near the articular facets 208a, 208b of the sacrum 200. A protrusion 24 is attached near the bottom lip 22 so as to engage the sacral cornu 212 and sacral hiatus 214 of the sacrum 200. A pair of protrusions is disposed along one of the side lips 30 so as to engage lateral sacral crest 210a and another pair of protrusions is disposed along the other of the side lips 30 so as to engage the lateral sacral crest 210b. In such an aspect, the user may remove any one of the protrusions 24 to better engage the sacrum 200 to align the sacrum 200.

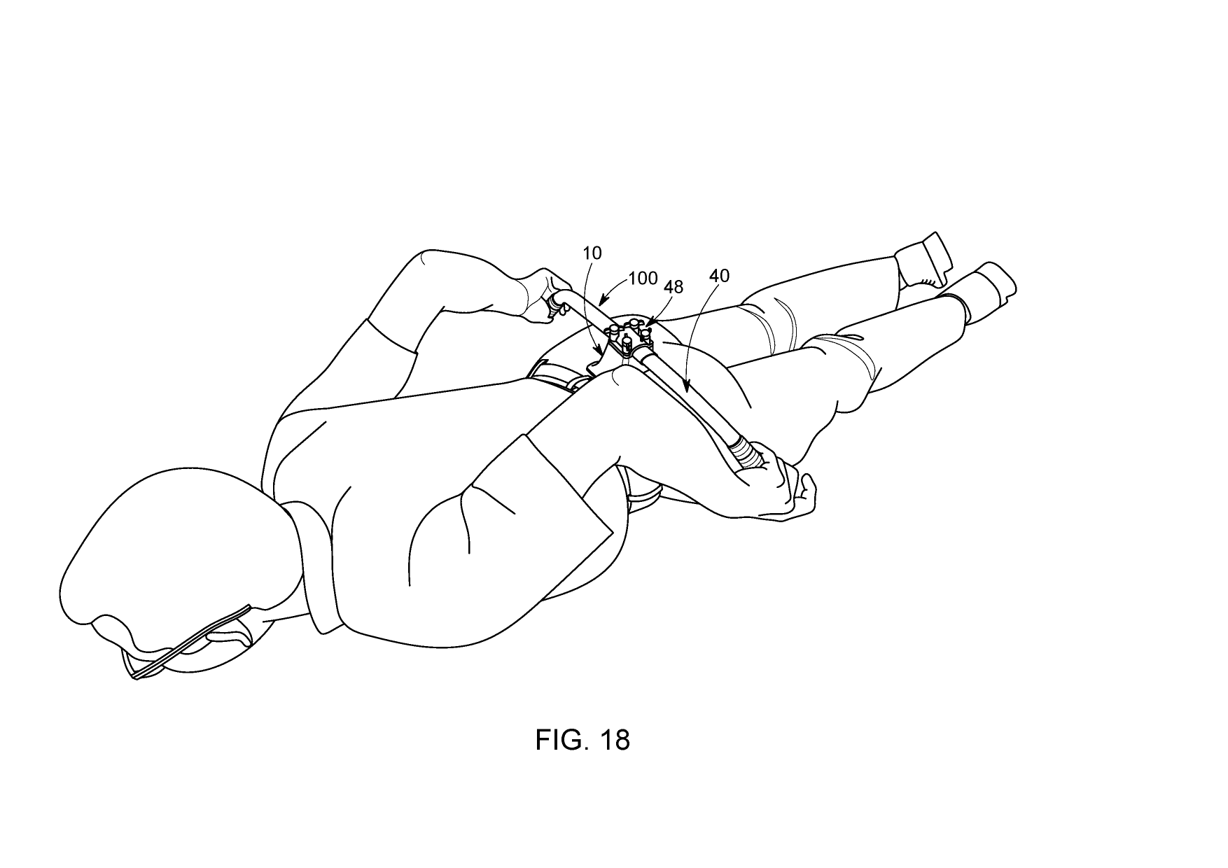

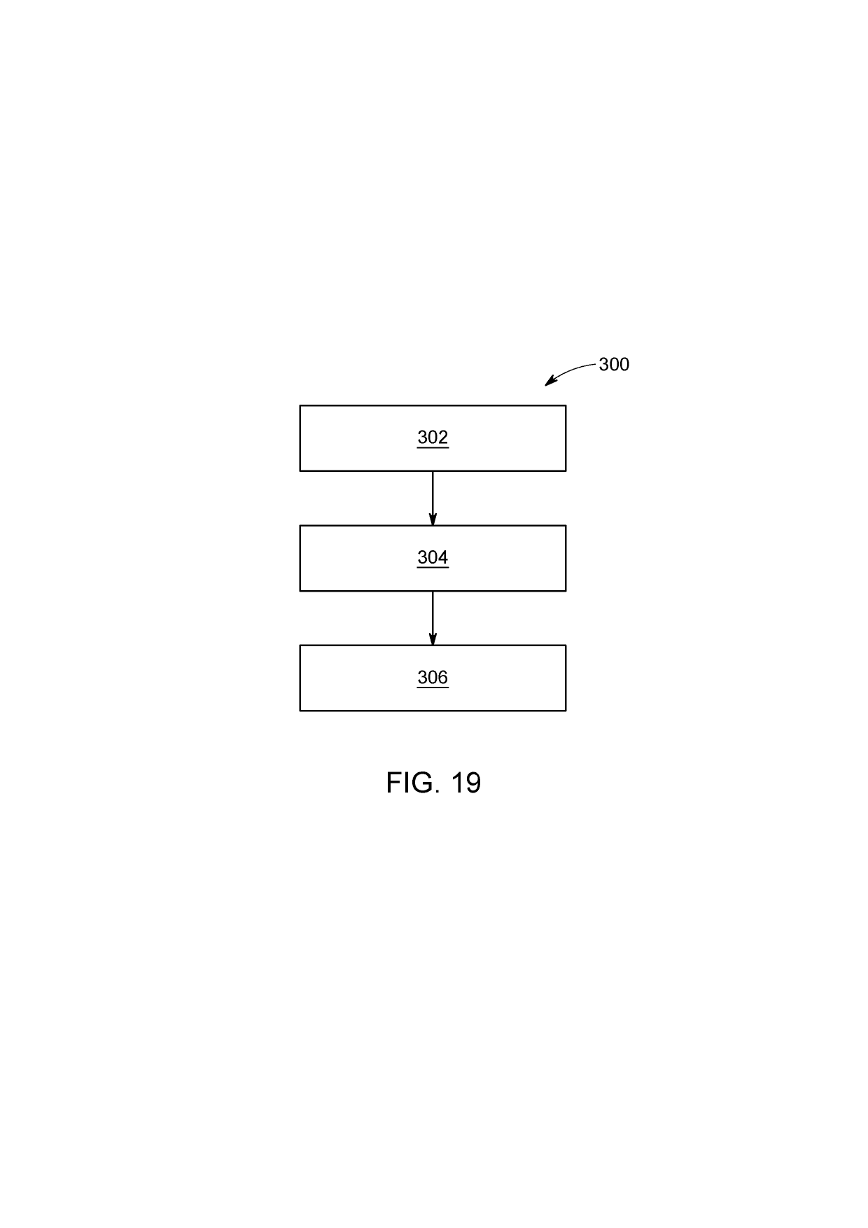

With continued reference to FIGS. 1-15, and with reference to FIGS. 16-21, a method 300 of aligning a sacrum 200 is provided. The method 300 includes, at 302, the step of providing a device 10 including a body 12 having a top portion 14 opposite a bottom portion 16, and a support portion 18. The top portion 14 and the bottom portion 16 are attached to the support portion 18. The body 12 further includes a top lip 20 opposite of a bottom lip 22, and a pair of side lips 30, wherein the top lip 20 and the bottom lip 22 each having a pair of ends 20a, 20b, 22a, 22b and the pair of side lips 30 interconnecting a corresponding pair of ends 20a, 20b of the top lip 20 to a corresponding pair of ends 22a, 22b of the bottom lip 22. A length of the top lip 20 is longer than a length of the bottom lip 22, and the pair of side lips 30 are arcuate so as to define a wedge-shaped structure having a depression 32 at a center portion 34 of the body 12 so as to form a shape generally inverse to the portions of the sacrum 200, that is to cup the sacrum 200. The method 300 further includes, at 304, the step of placing the device 10 onto the sacrum 200 so as to engage a top portion 202 of the sacrum 200 with the top lip 20 and a bottom portion 204 of the sacrum 200 with the bottom lip 22 and, at 306, the step of positioning the device 10 so as to grip at least one of the top portion 202 of the sacrum 200 and the bottom portion 204 of the sacrum 200 with the corresponding top lip 20, bottom lip 22 and side lip 30 so as to move the sacrum 200 to either a left position, a right position, a forward position or a back position until the sacrum 200 is aligned, that is the device 10 may be positioned to engage the sacrum 200 to move the sacrum in a superior or caudal directions and rotationally to the left/right, into nutation/counternutation or in a clockwise or counterclockwise direction. It should be appreciated that the device 10 may move the sacrum 200 by engaging the sacrum 200 with the top lip 20, bottom lip, and side lip 30 singularly, collectively or in combination with each other.

At step 308, the method 300 includes providing a plurality of protrusions 24 which may be selectively attached to the body 12 as to apply a pressure or otherwise grip a predetermined area of the sacrum 200. The protrusions 24 are generally bulbous members configured to extend outwardly beyond the outer surface of the body 12 so as to engage the sacrum 200 in manner where an outer surface of the body 12 is spaced apart from the sacrum 200. It should be appreciated that the compressibility of the protrusion 24 may be sufficient where both the protrusion 24 and a corresponding edge of the body 12 touch or otherwise apply pressure to the sacrum 200. In one aspect, the protrusions 24 may formed of a resilient material such as a cushioned foam and may be fixed to the body 12 by any known fixing means, to include a mechanical fastener such as a screw or an adhesive. In yet another aspect, the protrusions 24 may formed of a rigid and durable material such as a hard plastic. In another aspect, the protrusions 24 are detachably mounted onto the body 12. In such a case, the body 12 may include a first fastening strip and a bottom surface of the protrusions 24 may include a second fastening strip configured to releasably engage the first fastening strip. For instance, a pair of the plurality of protrusions 24 may be attached to the top lip 20 of the body 12 in succession so as to engage at or near the articular facets 208a, 208b of the sacrum 200. A protrusion 24 may be attached near the bottom lip 22 so as to engage the sacral cornu 212 and sacral hiatus 214 of the sacrum 200. One or multiple protrusions may be attached along one of the side lips 30 so as to engage lateral sacral crest 210a and another one or multiple protrusions may be attached along the other of the side lips 30 so as to engage the lateral sacral crest 210b. In such an aspect, the user may remove any one of the protrusions 24 to better engage the sacrum 200 to align the sacrum 200.

As an example, during operation of the tool 100, a user may use the tool 100 for purposes of manipulating the sacrum 200 of the user based upon the position of the sacrum 200. The manner in which the sacrum 200 is manipulated by the tool 100 varies and depends on the desired result. To initially position the tool 100 against the sacrum 200, the user may lie face-down and grip the tool 100 at the pair of grips 46 behind the user’s back. The top lip 20 of the device 10 engages with a top portion 202 of the sacrum, while the bottom lip 22 of the device 10 engages with a bottom portion 204 of the sacrum. This positioning is at or near the top one third of the glutes of the user. The user is then able to manipulate the sacrum 200 as desired.

For example, to align the sacrum 200, the top lip 20 of the device 10 is configured to grip the top portion 202 of the sacrum 200, just below the lower back of the user. Using the pair of grips 46, the user presses the tool 100 inward, toward the front of the user’s body, while simultaneously pressing the tool 100 downward toward the feet of the user. The force required may be within the realm of two pounds to five pounds of pressure. The user then holds this position for an extended period of time, such as, for example, 30 to 60 seconds, to align the sacrum 200.

In another example, if the user is attempting to alleviate SI joint pain, the user positions the tool 100 as described above. The pair of side lips 30 of the device 10 are configured to grip a pair of sides 206 of the sacrum 200. The user applies forces against either of the pair of grips 46 to level the sacrum 200 from either of the pair of sides 206 of the sacrum 200. This action is maintained until the pain experienced by the user dissipates. In another example, such as to correct a counter-nutated sacrum, the user positions the tool 100 as described above. The user applies force against the pair of grips 46 and directs the force toward the top lip 20 of the device 10. A sliding motion downward, toward the feet of the user, is performed by the user to press the top portion 202 of the sacrum 200. This action is repeated until the positioning of the sacrum 200 is corrected. In another example, such as to correct a nutated sacrum, the user positions the tool 100 as described above. The user applies force against the pair of grips 46 and directs force toward the bottom lip 22, partially rotating the tool 100 so as to press the bottom lip 22 inward toward the user’s body. This action is repeated until the positioning of the sacrum 200 is corrected.

It should be appreciated that the examples as described above are not fully encompassing, and the tool 100 may be used for sacrum manipulation in a variety of ways.

A number of implementations have been described. Nevertheless, it will be understood that various modifications may be made without departing from the spirit and scope of the disclosure. Any such assembly is but a variation of the embodiments discussed above, and does not depart from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A device for aligning a sacrum, the device comprising:
a body having a top portion opposite a bottom portion, and a support portion, the top portion and the bottom portion attached to the support portion, the body further including a top lip opposite of a bottom lip, and a pair of side lips, wherein the top lip and the bottom lip each having a pair of ends and the pair of side lips interconnecting a corresponding pair of ends of the top lip to a corresponding pair of ends of the bottom lip, wherein a length of the top lip is longer than a length of the bottom lip, and the pair of side lips are arcuate so as to define a wedge-shaped structure having a depression at a center of the body.

2. The device as set forth in claim 1, further including at least one protrusion.

3. The device as set forth in claim 2, wherein the protrusion is generally centered on the top lip between a first arcuate portion and a second arcuate portion.

4. The device as set forth in claim 1, including a plurality of ridges that are concentric to each other, wherein a smaller one of the plurality of ridges is recessed with respect to larger one of the plurality of ridges.

5. The device as set forth in claim 1, wherein one of the top lip and the bottom lip is arcuate so as to curve into the body.

6. The device as set forth in claim 2, wherein the at least one protrusion is formed of a resilient material and includes a plurality of protrusions, a pair of the plurality of protrusions is disposed in succession along the top lip, one of the plurality of protrusion is disposed along the bottom lip and another pair of the plurality of protrusions is disposed on a corresponding one of the pair of side lips.

7. The device as set forth in claim 1, wherein the bottom lip includes a pair of cut outs.

8. The device as set forth in claim 7, wherein each of the pair of cut outs is radiused.

9. The device as set forth in claim 1, wherein each of the pair of side lips is generally continuous along an axis from the pair of ends of the top lip and the pair of ends of the bottom lip.

10. A tool for aligning a sacrum, the tool comprising:
a bar;
a closure; and
a body having a top portion opposite a bottom portion, and a support portion, the support portion configured to be coupled to the closure so as to fix the bar therebetween, wherein the top portion and the bottom portion attached to the support portion, the body further including a top lip opposite of a bottom lip, and a pair of side lips, wherein the top lip and the bottom lip each having a pair of ends and the pair of side lips interconnecting a corresponding pair of ends of the top lip to a corresponding pair of ends of the bottom lip, wherein a length of the top lip is longer than a length of the bottom lip, and the pair of side lips are arcuate so as to define a wedge-shaped structure having a depression at a center of the body.

11. The tool as set forth in claim 10, further including at least one protrusion.

12. The tool as set forth in claim 11, wherein one of the top lip and the bottom lip is arcuate so as to curve into the body.

13. The tool as set forth in claim 12, wherein the at least one protrusion is formed of a resilient material and includes a plurality of protrusions, a pair of the plurality of protrusions is disposed in succession along the top lip, one of the plurality of protrusion is disposed along the bottom lip and another pair of the plurality of protrusions is disposed on a corresponding one of the pair of side lips.

14. The tool as set forth in claim 13, wherein each of the at least one protrusion is removably attached to the body.

15. The tool as set forth in claim 10, wherein the bottom lip includes a pair of cut outs.

16. The tool as set forth in claim 15, wherein each of the pair of cut outs is radiused.

17. The tool as set forth in claim 10, wherein each of the pair of side lips is generally continuous along an axis from the pair of ends of the top lip and the pair of ends of the bottom lip.

18. The tool as set forth in claim 10, wherein the support portion includes a first mounting groove and the closure includes a second mounting groove, each having a radius that is collectively configured to enclose the bar.

19. A method of aligning a sacrum comprising the steps of:
providing a device including a body having a top portion opposite a bottom portion, and a support portion, the top portion and the bottom portion attached to the support portion, the body further including a top lip opposite of a bottom lip, and a pair of side lips, wherein the top lip and the bottom lip each having a pair of ends and the pair of side lips interconnecting a corresponding pair of ends of the top lip to a corresponding pair of ends of the bottom lip, wherein a length of the top lip is longer than a length of the bottom lip, and the pair of side lips are arcuate so as to define a wedge shaped structure having a depression at a center of the body;
placing the device onto the sacrum so as to engage a top portion of the sacrum with the top lip and a bottom portion of the sacrum with the bottom lip;
positioning the device so as to grip at least one of the top portions of the sacrum and the bottom portion of the sacrum with the corresponding top lip and bottom lip so as to move the sacrum in the superior or caudal directions and rotationally to the left/right, into nutation/counternutation or in a clockwise or counterclockwise direction until the sacrum is aligned.

20. The method as set forth in claim 19, further including the step of providing at least one protrusion, and selectively placing the at least one protrusion on the body so as to apply a pressure onto a predetermined area of the sacrum.
